(19) United States
(12) Patent Application Publication
(10) Pub. No.: US 2019/0225125 A1
(43) Pub. Date: Jul. 25, 2019

(54) EXTENDABLE VEHICLE SEAT LUMBAR SUPPORT USING RACK AND PINION

(71) Applicants: GUMCHANG. CO., LTD., Gyeongsangbuk-do (KR); ASAN GUMCHANG CO., LTD., Chungcheongnam-do (KR)

(72) Inventors: Jae-Yel SONG, Daegu (KR); Hai-Tai CHOI, Gyeongsangbuk-do (KR); Cheol HEO, Gyeongsangbuk-do (KR); Sae-Gil SHIN, Daegu (KR); Hyang-Mo NAM, Gyeongsangbuk-do (KR); Sang-Ho LEE, Daegu (KR); Ho-Young CHOI, Daegu (KR); Min-Sung KIM, Gyeongsangbuk-do (KR); Ho-Gil JEONG, Gyeongsangbuk-do (KR); Sung-Su PARK, Gyeongsangbuk-do (KR)

(21) Appl. No.: 15/877,743

(22) Filed: Jan. 23, 2018

(51) Int. Cl. B60N 2/66

(52) U.S. Cl. CPC B60N 2/667

(57) ABSTRACT

A vehicle seat lumbar support including: brackets located on both sides of a seat back frame; a fixing unit having guides for guiding an operating unit and a driver including a motor having a driving shaft, a worm fitted to the driving shaft of the motor, a worm gear rotating by the worm, and a pinion gear fitted to a shaft of the worm gear; and an operating unit driven by the driver and including a block band having base blocks having hooks formed on underside surfaces thereof, a base band for locking the hooks of the base blocks thereonto in such a manner as to be coupled to the guides on top and underside of one side thereof, and a rack gear formed on the base band in such a manner as to engage with the pinion gear fitted to the shaft of the worm gear.

### BACKGROUND

The present invention relates to an aluminum coil assembly having a galvanic corrosion prevention structure for a car electromagnetic clutch, and more particularly, to an aluminum coil assembly having a galvanic corrosion prevention structure for a car electromagnetic clutch that is capable of preventing the occurrence of galvanic corrosion on a structure where an aluminum electromagnetic coil comes into electrical contact with a steel housing by means of a ground ring.

The present invention relates to a vehicle seat lumbar support that is built in an interior of a seat back to support a passenger's back and waist thereagainst, and more particularly, to an extendible vehicle seat lumbar support using a rack and pinion that is provided with a driver for driving the lumbar support with a rack and pinion (hereinafter, referred to as “a rack gear” and “a pinion gear”), the driver being fabricated and assembled simply through injection molding.

Generally, a vehicle seat is adjustable at position or angle according to the physical conditions of a passenger to allow the passenger to sit thereon safely and comfortably, and a portion of the seat for resting a back of the passenger is called a seat back.

A human's waist region is more concaved inwardly than the back region, and accordingly, given bending is needed on the seat back. In this case, every man has his own physical conditions, and accordingly, a protrusion degree of a waist portion from the seat back is adjusted to obtain optimal supporting effects.

To this end, a vehicle seat lumbar support, which is built in the interior of the seat back, is suggested so that the protrusion degree of the waist portion from the seat back is adjusted to comfortably support the waist of the passenger and to reduce his or her fatigue while he or she is driving.

In case of conventional vehicle seat lumbar supports, however, the number of components thereof is substantially large and the configuration thereof is complicated, which causes some structural disadvantages. That is, operation reliability is lowered due to long term use, the device is not lightweight, and a vehicle price as well as a production cost is raised.

So as to solve the above-mentioned problems, there is proposed Korean Patent Registration No. 10-1372957 entitled ‘lumbar support for vehicle seat’, and in this case, the lumbar support is simple in structure to achieve lightweight. Referring to the structure of the conventional lumbar support, a pair of plate springs protrudes by means of a pair of hinge modules coupled to both sides of a seat back frame in such a manner as to protrude in a direction facing each other, and the lumbar support is connected to the pair of plate springs to support a passenger's waist.

However, it is impossible to fabricate the conventional lumbar support having the above structure with injection-molded synthetic resin, and accordingly, most of parts of the lumbar support are made from metals and coupled to each other, thereby causing many structural problems like the increment of a production cost, the restriction in lightweight, and so on.

### SUMMARY OF THE INVENTION

Accordingly, the present invention has been made in view of the above-mentioned problems occurring in the prior art, and it is an object of the present invention to provide an extendible vehicle seat lumbar support using a rack and pinion that perfectly performs functions, as the lumbar support, of supporting a passenger's back and waist portions and adjusting a degree of protrusion according to the passenger's physical condition to comfortably support his or her body, that is simple in configuration to ensure the reliability of operation, and that is provided with a driver using the rack and pinion that is formed as a unitary body by means of injection molding, so that the lumbar support is fabricated and assembled in a simple manner to achieve cost reduction and lightweight.

To accomplish the above-mentioned object, according to the present invention, there is provided an extendable vehicle seat lumbar support using a rack and pinion, comprising: brackets located on both sides of a seat back frame for keeping a shape of a seat back to install the lumbar support on both sides thereof; a fixing unit having guides for guiding an operating unit and a driver for driving the operating unit, the driver comprising a motor having a driving shaft, a worm fitted to the driving shaft of the motor, a worm gear rotating by the worm, and a pinion gear fitted to a shaft of the worm gear; and the operating unit driven by the driver and comprising a block band having base blocks having hooks formed on underside surfaces thereof, a base band for locking the hooks of the base blocks thereonto in such a manner as to be coupled to the guides on top and underside of one side thereof, and a rack gear formed on the base band in such a manner as to engage with the pinion gear fitted to the shaft of the worm gear, whereby through the operation of the driver, the operating unit and the fixing unit are closely tightened or loosened.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing an extendible vehicle seat lumbar support using a rack and pinion according to the present invention, wherein the lumbar support is mounted on a seat back frame;

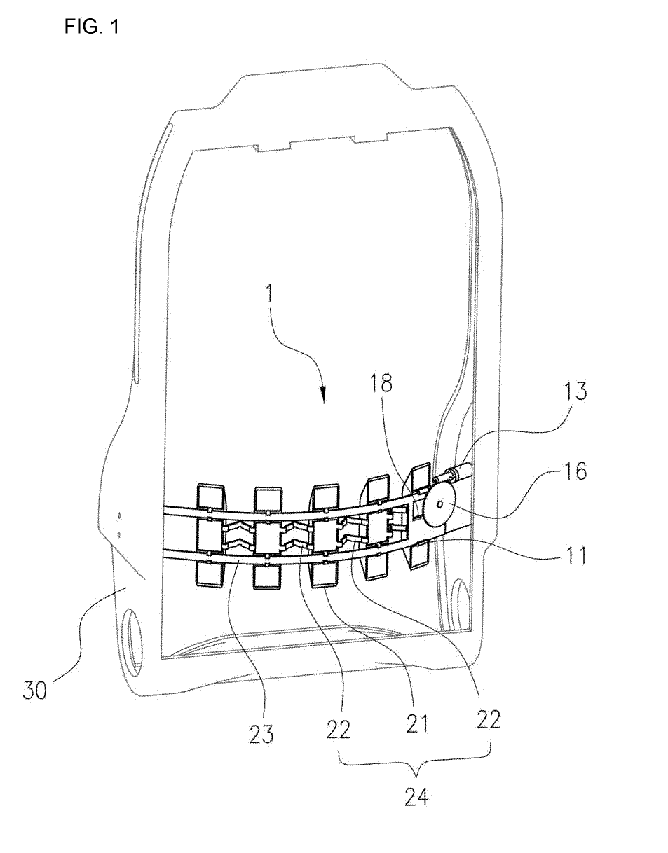

FIG. 2 is a perspective view showing the main parts of the lumbar support according to the present invention;

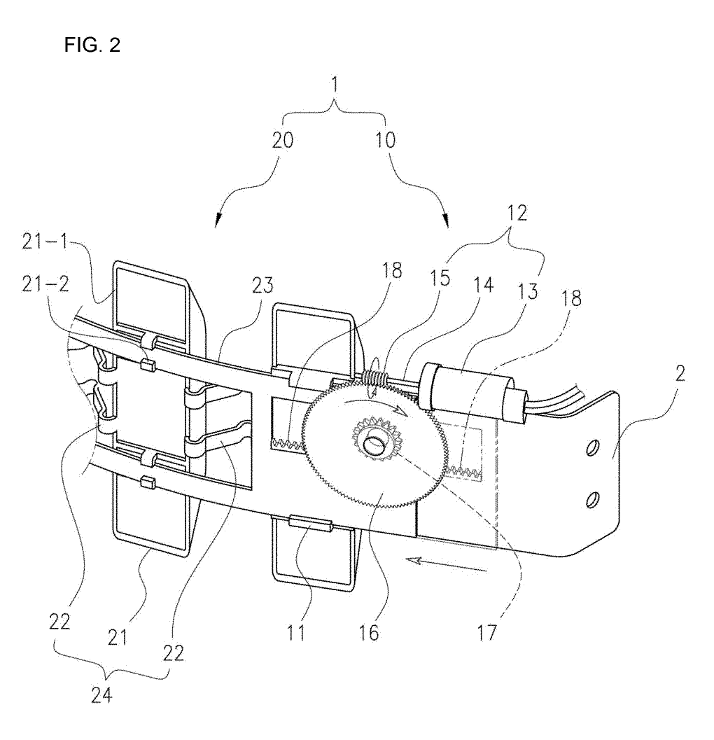

FIG. 3 is an exploded perspective view showing the main parts of the lumbar support according to the present invention;

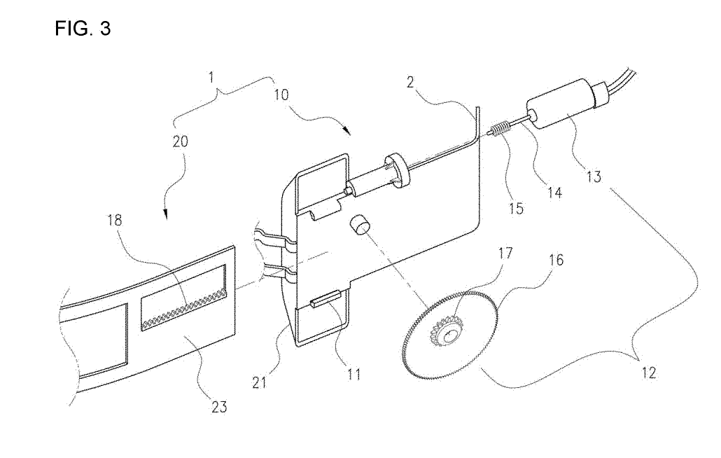

FIG. 4 is a plan view showing the operating state of the lumbar support according to the present invention; and

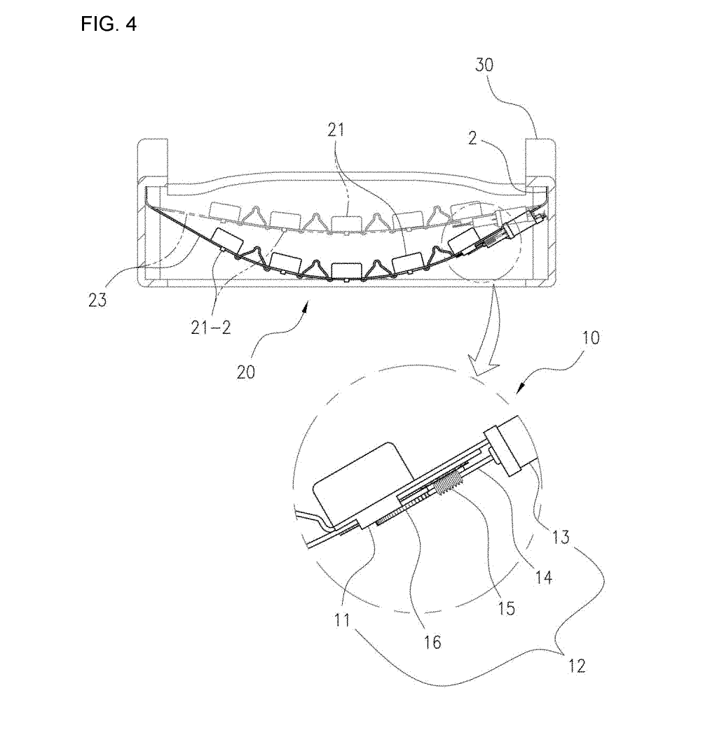

FIG. 5 is perspective views showing the operating states of the lumbar support according to the present invention.

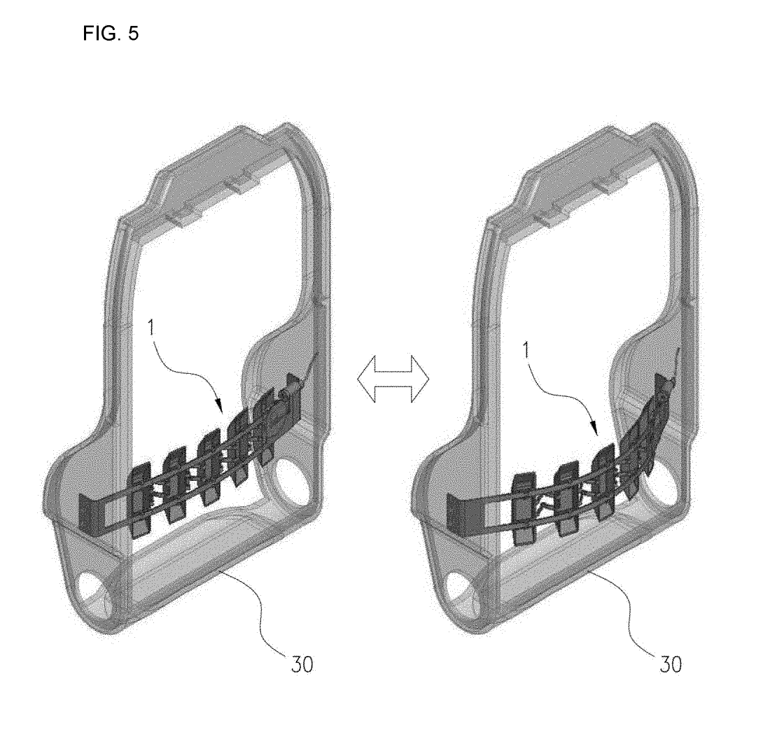

### DETAILED DESCRIPTION OF THE PREFERRED EMBODIMENTS

Now, an explanation on an extendible vehicle seat lumbar support using a rack and pinion according to the present invention will be given with reference to the attached drawings.

So as to provide an extendible vehicle seat lumbar support 1 using a rack and pinion according to the present invention, brackets 2 are located on both sides of a seat back frame 30 for keeping a shape of a seat back to install the lumbar support 1 on both sides thereof.

The lumbar support 1 has a fixing unit 10 and an operating unit 20 in such a manner as to be extendable and contractible. The fixing unit 10 includes guides 11 for guiding the operating unit 20 and a driver 12 for driving the operating unit 20.

The driver 12 includes a motor 13 having a driving shaft 14, a worm 15 fitted to the driving shaft 14 of the motor 13, a worm gear 16 rotating by the worm 15, and a pinion gear 17 fitted to a shaft of the worm gear 16.

The operating unit 20, which is driven by the driver 12, includes: a block band 24 having base blocks 21 having hooks 21-2 formed on underside surfaces 21-1 thereof and bent bands 22 connected to left and right sides of the respective base blocks 21; and a base band 23 for locking the hooks 21-2 of the base blocks 21 thereonto in such a manner as to be coupled to the guides 11 on top and underside of one side thereof.

Also, one side of the block band 24 having the base blocks 21 and the bent bands 22 connected to the left and right sides of the respective base blocks 21 is connected to the base band 23 of the operating unit 20, and the other side of the block band 24 is connected to the fixing unit 10, so that when the base band 23 pulls toward the fixing unit 10 or pushes toward the opposite direction to the fixing unit 10, the bent bands 22 of the block band 24 are folded or unfolded to move the base blocks 21, and a rack gear 18 formed on the inner surface of one side of the base bands 23 and engages with the pinion gear 17 fitted to the shaft of the worm gear 16. Through the operation of the driver 12, as a result, the operating unit 20 and the fixing unit 10 are closely tightened or loosened.

A reference numeral 50 not explained in the drawing indicates a seat back, and a reference numeral 51 indicates a worm cover.

Under the above-mentioned configuration, now, an explanation on an operation of the lumbar support according to the present invention will be given below.

First, the operating unit 20, which includes the base blocks 21 having the hooks 21-2 formed unitarily with the underside surfaces 21-1 thereof and the bent bands 22 connected to the left and right sides of the respective base blocks 21, is fabricated by means of injection molding, so that the operating unit 20 can be simply fabricated and lightweight.

Next, the guides 11 are located on the fixing part 10 to guide the operating unit 20, and the driver 12 for driving the operating unit 20 has the configuration wherein the worm 15 is mounted on the driving shaft 14 of the motor 13, the worm gear 16 is mounted to rotate by the worm 15, and the pinion gear 17 is fitted to the shaft of the worm gear 16, so that the operating unit 20 can be simply fabricated and lightweight by means of injection molding.

After that, the brackets 2 disposed on both sides of the lumbar support 1 according to the present invention are fixedly located on both sides of the seat back frame 30.

In the state where the lumbar support 1 is installed on the seat back frame 30, if it is desired to allow the seat back 50 to protrude, the motor 13 of the driver 12 located on the fixing unit 10 of the lumbar support 1 rotates forwardly, and accordingly, the worm 15 fitted to the driving shaft 14 of the motor 13 rotates to allow the worm gear 16 and the pinion gear 17 engaging sequentially with the worm 15 to rotate.

As a result, the rack gear 18 engaging with the pinion gear 17 moves, and accordingly, the operating unit 20 having the rack gear 18 moves to the fixing unit 10, so that the lumbar support 1 is contracted to allow the seat back 50 to protrude.

If it is desired to return the seat back 50 to its original position, further, the motor 13 of the driver 12 rotates reversely, and accordingly, the worm 15 fitted to the driving shaft 14 of the motor 13 rotates reversely to allow the worm gear 16 and the pinion gear 17 engaging sequentially with the worm 15 to rotate reversely.

As a result, the rack gear 18 engaging with the pinion gear 17 moves to the opposite side to the fixing unit 10, and accordingly, the operating unit 20 having the rack gear 18 moves to a side distant from the fixing unit 10, so that the lumbar support 1 is extended to allow the seat back 50 to be returned to its original state.

In this case, one side of the block band 24 having the base blocks 21 and the bent bands 22 connected to the left and right sides of the respective base blocks 21 is connected to the base band 23 of the operating unit 20 and the other side of the block band 24 is connected to the fixing unit 10, so that when the base blocks 21 are spaced apart from each other by a constant distance to the left and right sides thereof and when the lumbar support 1 is extended or contracted, the block band 24 becomes also extended or contracted.

Further, the hooks 21-2 formed on the underside surfaces 21-1 of the base blocks 21 are locked on the base band 23, so that the operating unit 20 and the fixing unit 10 perform the extension and contraction operation gently, without any escape from each other, and moreover, the base blocks 21 serve to massage a user's back.

As described above, the extendible vehicle seat lumbar support using the rack and pinion according to the present invention is provided with the driver that adjusts the length of the lumbar support to perfectly perform the functions of comfortably supporting the passenger's back and waist portions and is simple in configuration to ensure the reliability of operation.

In addition, the extendible vehicle seat lumbar support using the rack and pinion according to the present invention is simple in configuration and fabricated by means of injection molding, so that the lumbar support can be easily fabricated and assembled to the seat back frame, thereby achieving improvements in productivity, high economical effects, the decrement in the number of parts and weight thereof, and lightweight vehicle.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An extendable vehicle seat lumbar support (1), comprising:
brackets (2) located on both sides of a seat back frame (30) for keeping a shape of a seat back to install the lumbar support (1) on both sides thereof; and
a fixing unit 10 having guides (11) for guiding an operating unit (20) and a driver (1 2) for driving the operating unit (20), the driver (12) comprising a motor (1 3) having a driving shaft (14), a worm (1 5) fitted to the driving shaft (14) of the motor (13), a worm gear (16) rotating by the worm (1 5), and a pinion gear (1 7) fitted to a shaft of the worm gear (16); and
the operating unit (20) driven by the driver (12) and comprising base blocks (21) having hooks (21-2) formed on underside surfaces (21-1) thereof, a base band (23) for locking the hooks (21-2) of the base blocks (21) thereonto in such a manner as to be coupled to the guides (11) on top and underside of one side thereof, and a rack gear (18) formed on the base band (23) in such a manner as to engage with the pinion gear (1 7) fitted to the shaft of the worm gear (16),
whereby through the operation of the driver (12), the operating unit (20) and the fixing unit (10) are closely tightened or loosened.

2. The lumbar support according to claim 1, wherein the operating unit (20) comprises bent bands (22) connected to left and right sides of the respective base blocks (21).

3. The lumbar support according to claim 1, wherein the rack gear (18) engaging with the pinion gear (1 7) fitted to the shaft of the worm gear (16) is formed on the inner surface of one side of the base band (23).

4. The lumbar support according to claim 2, wherein the base blocks (21) and the bent bands (22) constitute a block band (24), one side of the block band (24) being connected to the base band (23) of the operating unit (20) and the other side of the block band (24) being connected to the fixing unit (10).
